(19) United States
(12) Patent Application Publication
(10) Pub. No.: US 2026/0254205 A1
(43) Pub. Date: Aug. 27, 2026

(54) SPARK PLUG RESISTOR ELEMENT ARRANGEMENT, METHOD FOR PRODUCING SAME, AND SPARK PLUG FOR AN INTERNAL COMBUSTION ENGINE

(71) Applicant: Robert Bosch GmbH, Stuttgart (DE)

(72) Inventors: Benedikt Reinsch, Riederich (DE); Carsten Kuenzel, Tamm (DE); Hubertus Braun, Renningen (DE); Stefan Nufer, Stuttgart (DE)

(21) Appl. No.: 18/725,843

(22) PCT Filed: Jan. 9, 2023
(86) PCT No.: PCT/EP2023/050315

§ 371 Date: Jul. 1, 2024

(30) Foreign Application Priority Data
Jan. 17, 2022 (DE) 10 2022 200 450.7

(51) Int. Cl. H01T 13/38; H01T 13/04; H01T 21/02

(52) U.S. Cl. CPC H01T 13/38; H01T 13/04; H01T 21/02

(57) ABSTRACT

A spark plug resistor element arrangement. The arrangement, in the following order, includes an electrically conductive combustion-chamber-side end portion, a resistor element including a resistance material, and an electrically conductive connection-side end portion. The resistor element has a porosity of less than 0.3%.

### FIELD

The present invention relates to a spark plug resistor element arrangement with homogeneous current density distribution and reduced electrical load, resulting in long product durability. In addition, the present invention also relates to a method for producing the spark plug resistor element arrangement and to a spark plug for an internal combustion engine that is characterized by improved operational life due to the use of the spark plug resistor element arrangement.

### BACKGROUND INFORMATION

German Patent Application No. DE 10 2009 047 055 A1 describes a spark plug for an internal combustion engine, which comprises an insulator with a bore into which a paste is introduced, which comprises a first contact paste, a second contact paste and an intermediate resistance paste, wherein the second contact paste is connected to a center electrode of the spark plug and the first contact paste is connected to an electrical connection bolt. The chemical compounds and/or chemical elements used for the resistance paste are characterized by a specifically set electrical resistance and are formed into the resistance paste without special processing by mixing and compacting in a bore provided in the insulator of the spark plug. Normally achieved porosities achieved in this case are in a range of more than 5%, in particular of more than 10%. This results in a relatively short service life of the spark plug.

### SUMMARY

A spark plug resistor element arrangement according to features of the present invention is characterized by very good durability and permanently high performance due to a homogeneous current density distribution and a lack or small number of regions with increased electrical load. The spark plug resistor element arrangement according to the present invention also has a lower tendency to electrical malfunction, which secondarily also prevents complete failure of a spark plug in which the spark plug resistor element arrangement is installed.

For this purpose, the spark plug resistor element arrangement according to an example embodiment of the present invention comprises, in this order, an electrically conductive combustion-chamber-side end portion, an electrical resistor element comprising a resistance material, and an electrically conductive connection-side end portion. The respective end portions ensure good connection of the resistor element to surrounding spark plug components, such as a center electrode at the combustion-chamber-side end portion and an electrical connection region at the connection-side end portion, when used as intended. Further components may be provided.

According to an example embodiment of the present invention, the resistor element comprises a resistance material and has a porosity of less than 0.3%. This means that the resistor element can be formed from one or more resistance materials, which together form the resistor element, wherein the porosity of the entire resistor element in the spark plug resistor element arrangement is however less than 0.3%. After the production of the resistor element, the porosity thereof is measured by means of microstructural characterization on micrographs in the scanning electron microscope (SEM) (see:

determination of the volume fraction of phases by evaluation of microstructure images, wherein the porosity is ascertained here analogously to a second structure phase; reference is made to EN ISO 13383-2:2016 in this respect).

Without being bound to any theory, it is assumed that a porosity of less than 0.3% results in a high and homogeneous density of the resistance material with only few and small cavities between the material particles. As a result, the material particles in the resistance material are in good contact with one another so that locally forming regions with increased electrical load can be prevented or at least significantly reduced so that electrical malfunction can be ruled out. This in turn improves the operational performance of the spark plug resistor element arrangement. The intended use of the spark plug resistor element arrangement according to the present invention thus also improves the operational performance of the products in which it is installed.

According to an example embodiment of the present invention, preferably, the spark plug resistor element arrangement has an electrical resistance of 1 to 14 kΩ, in particular of 3 to 10 kΩ. According to the present invention, the electrical resistance is determined according to JIS B 8031 (from the year 2006), chapter 7.13 at a measuring temperature of T=20 C.

Preferred example developments of the present invention are disclosed herein.

According to an advantageous development of the present invention, the resistor element has a porosity of at least 0.05%. The lower limit of 0.05% is advantageous in light of a simplified production of the resistor element. Higher compactions would mean higher technical effort that directly impacts the production costs of the spark plug resistor element arrangement.

In light of a balance between high costs for producing the spark plug resistor element arrangement on the one hand and improved current density distribution on the other hand, the resistor element has a porosity of 0.05 to 0.30%, in particular of 0.10 to 0.25%.

According to an example embodiment of the present invention, in order to improve the electrical connection of the resistor element to a combustion chamber or to an electrical connection when using the spark plug resistor element arrangement in a spark plug for internal combustion engines, the electrically conductive combustion-chamber-side end portion of the spark plug resistor element arrangement advantageously comprises a contact paste and/or the electrically conductive connection-side end portion advantageously comprises a contact paste. A contact paste within the meaning of the present invention is an element formed inter alia from electrically conductive particles, which element can be connected geometrically accurately to the component to be respectively connected in the intended use and on the other hand provides good electrical contact to the resistor element. In particular, the contact paste is composed of composite materials consisting at least of electrically insulating glass particles and electrically conductive materials, such as metals (iron, copper, etc.) and/or carbon-containing compounds (graphite, carbon black, SiC, etc.).

According to an example embodiment of the present invention, in order to further improve the connectability of the spark plug resistor element arrangement to an electrical connection, the electrically conductive connection-side end portion preferably comprises a contact pin. The contact pin may be formed as a bolt and may simultaneously also be used to produce the spark plug resistor element arrangement in that it contributes to compacting the resistance material.

Most times, the contact pin is a metal-based, more or less cylindrical element, which in length is adapted to a bore inside an insulator of a spark plug into which the spark plug resistor element arrangement can be installed.

According to a further advantageous development of the present invention, a contact pin adjoins the connection-side contact paste on the connection side. This likewise serves to improve the connection to an electrical connection and preferably also to facilitate the production of a highly compacted resistor element.

According to an example embodiment of the present invention, in order to achieve a porosity of the resistor element of less than 0.3%, it is advantageously provided to use a resistance material that has a maximum primary particle size of less than 10 μm. The term “primary particle size” is understood to mean the particle size of the particular starting material prior to mixing the same and forming the resistor element. If two or more resistance materials are used, each of the resistance materials used has a primary particle size of less than 10 μm. Resistance materials with a primary particle size of less than 10 μm have proven to be particularly easy to compact and process into a highly compacted resistor element. According to the present invention, the primary particle size is ascertained by means of microstructural characterization on micrographs in the scanning electron microscope (SEM), namely via the determination of the grain size and grain size distribution according to method B in chapter 9.3 of EN ISO 13383-1:2012.

According to an example embodiment of the present invention, in light of good processability while avoiding dust formation, a resistance material with a minimum primary particle size of 5 nm and in particular of 10 nm is in particular used.

According to an example embodiment of the present invention, in consideration of the aforementioned effects for a minimum and a maximum primary particle size of the resistance material(s), the resistance material has a primary particle size of 5 nm to less than 10 μm, in particular of 10 nm to less than 10 μm, and in particular of 100 nm to 5 μm. These materials are easy to produce, easy to handle, and have little tendency to dust formation. All of the above size information applies to all resistance materials used in the spark plug resistor element arrangement.

Due to the very good settability of a predefined resistance value, the resistance material comprises a borosilicate glass and ZrO₂. It may also contain further compounds and elements, for example carbon-based substances, such as soot and the like, or titanium dioxide.

Furthermore, according to an example embodiment of the present invention, a method for producing a spark plug resistor element arrangement as described above is also disclosed. According to the present invention, the method comprises a step of comminuting the resistance material to a primary particle size of less than 10 μm, in particular of 5 nm to less than 10 μm, in particular of 10 nm to less than 10 μm, and in particular of 100 nm to 5 μm. Comminuting, which can be performed with any device, such as a bead mill or agitator ball mill, has the result that the resistance material can be highly compacted to form the resistor element. When forming the resistor element, fewer cavities can form between the individual particulars, leading primarily to a porosity of the resistor element of less than 0.3% and, consequently, to a particularly homogeneous current density distribution when installing the spark plug resistor element arrangement in a spark plug for internal combustion engines. Local regions with increased electrical load can be effectively prevented by installing resistance material, comminuted according to the present invention, in the resistor element. The method is highly efficient and can be implemented in a technically simple manner.

According to an example embodiment of the present invention, in addition to the step described above, further method steps, such as arranging an electrically conductive combustion-chamber-side end portion and an electrically conductive connection-side end portion at the resistor element, can follow. Compacting the resistance material to form the resistor element can also be performed, for example by means of a contact pin, which is guided from sides of the electrically conductive connection-side end portion.

Furthermore, according to an example embodiment of the present invention, a spark plug for an internal combustion engine is also disclosed, which comprises a spark plug resistor element arrangement as described above. Due to the installation of the spark plug resistor element arrangement according to the present invention in the spark plug according to the present invention, the spark plug also has an extended service life or operational life since electrical malfunction is avoided and a homogeneous current density distribution is achieved.

In addition to the spark plug resistor element arrangement according to an example embodiment of the present invention, the spark plug may comprise further components, for example as described in the stated related art, such as a center electrode, a ground electrode, a housing containing an insulator, wherein the spark plug resistor element arrangement is arranged in a bore in the insulator and is connected to the center electrode on the combustion chamber side and to the electrical connection of the spark plug on the connection side.

### BRIEF DESCRIPTION OF THE DRAWING

An embodiment example of the present invention is described in detail below with reference to the figure.

FIG. 1 shows a partially sectional view of a spark plug according to one example embodiment of the present invention.

### DETAILED DESCRIPTION OF EXAMPLE EMBODIMENTS

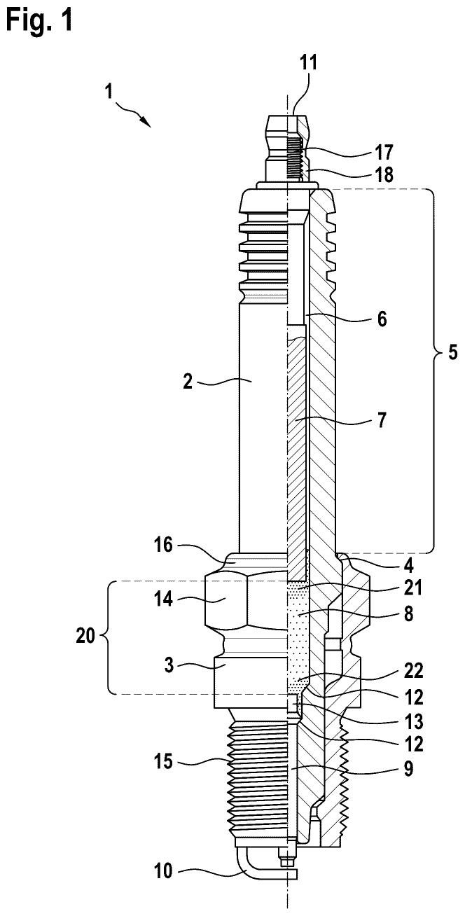

FIG. 1 shows a spark plug 1 according to one embodiment. The spark plug 1 comprises an insulator 2, a housing 3, a contact pin 7 designed as a connection bolt, a spark plug resistor element arrangement 20, a center electrode 9, a ground electrode 10 and a connection nut 18. The insulator 2 has a continuous cavity 6 over its entire length. This cavity 6 contains the center electrode 9, the spark plug resistor element arrangement 20 and the contact pin 7 in this sequence. Reference sign 5 denotes an insulator head.

The connection nut 18 is screwed onto the connection bolt outside the insulator 2. The spark plug resistor element arrangement 20 comprises an electrically conductive connection-side end portion 21 formed as a first contact paste, an electrically conductive combustion-chamber-side end portion 22 formed as a second contact paste, and a resistor element 8 arranged between the first contact paste and the second contact paste.

The cavity 6 in the insulator is cylindrical and extends from the connection-side start (away from the combustion chamber) of the insulator 2 to a multi-stage taper 12. At the multi-stage taper 12, the cavity 6 in the insulator 2 provides a support for a center electrode head 13 of the center electrode 9.

The spark plug resistor element arrangement 20 extends approximately from the center of the insulator shoulder 4 to the multi-stage transition 12. Located in the region of the transition 12 is preferably only the second contact paste, but not a resistor element 8, so that the maximum possible spread of the resistance value is produced.

On a side near the combustion chamber, the center electrode head 13 is inserted in the second contact paste. On a side away from the combustion chamber, the connection bolt is inserted in the first contact paste.

The spark plug resistor element arrangement 20 comprises a resistance material that is preferably fitted into the cavity 6 by casting and is formed as a resistor element 8 after solidification.

The connection bolt is immersed in the first contact paste and is firmly connected to the finished spark plug resistor element arrangement 20.

The housing 3 is seated on the outside of the insulator 2.

This housing 3 extends from a connection-side side (away from the combustion chamber) of the insulator shoulder 4 to the combustion-chamber-side end of the insulator 2. The ground electrode 10 is attached to the housing 3 at this combustion-chamber-side end of the insulator 2. The housing 3 furthermore comprises a hexagon head 14, an external thread 15, and a flared collar 16. The hexagon head 14 and the thread 15 serve to screw the spark plug 1 into an internal combustion engine, in particular into a cylinder head.

At the connection-side end, the connection bolt projects with a projecting portion 17 beyond the insulator 2. This projecting portion 17 is provided with a thread onto which the connection nut 18 is screwed. The length of the projecting portion 17 is selected such that, together with the connection nut 18, it forms the flush termination 11.

The resistor element 8 comprises a resistance material, in particular a borosilicate glass and ZrO₂, wherein ZrO₂ is a ceramic material. The resistance material may also contain further components, such as soot or other electrically conductive carbon materials. The resistance material or all resistance materials used for the resistor element 8 have a maximum primary particle size of less than 10 μm prior to the processing into the resistor element 8 and in particular have a minimum primary particle size of 0.5 nm, in particular of 5 nm, and in particular of 10 nm. The desired particle size can be achieved by comminuting the particular resistance material.

The resistor element 8 is formed from the comminuted resistance material(s), in particular by casting and/or compacting in the cavity 6, wherein a porosity of the resistor element 8 is less than 0.3%, and in particular 0.05 to 0.28%. This results in a highly compacted resistor element 8, in which the particles of the resistance material are very close to one another and few cavities exist between the particles. This results in a very homogeneous current density distribution, which is characterized by low electrical malfunction and thus imparts a high service life and high operational performance to the spark plug resistor element arrangement 20 and thus also to the spark plug 1.

1-12. (canceled)

13. A spark plug resistor element arrangement comprising, in the following order:
an electrically conductive combustion-chamber-side end portion;
a resistor element including a resistance material; and
an electrically conductive connection-side end portion;
wherein the resistor element has a porosity of less than 0.3%.

14. The spark plug resistor element arrangement according to claim 13, wherein the resistor element has a porosity of at least 0.05%.

15. The spark plug resistor element arrangement according to claim 13, wherein the resistor element has a porosity of 0.05 to 0.30%.

16. The spark plug resistor element arrangement according to claim 13, wherein: (i) the electrically conductive combustion-chamber-side end portion includes a contact paste, and/or (ii) the electrically conductive connection-side end portion includes a contact paste.

17. The spark plug resistor element arrangement according to claim 13, wherein the electrically conductive connection-side end portion includes a contact pin.

18. The spark plug resistor element arrangement according to claim 16, wherein a contact pin adjoins the connection-side contact paste on the connection side.

19. The spark plug resistor element arrangement according to claim 16, wherein the resistance material has a maximum primary particle size of less than 10 μm.

20. The spark plug resistor element arrangement according to claim 19, wherein the resistance material has a minimum primary particle size of 5 nm.

21. The spark plug resistor element arrangement according to claim 19, wherein the resistance material has a primary particle size of 5 nm to less than 10 μm.

22. The spark plug resistor element arrangement according to claim 13, wherein the resistance material includes a borosilicate glass and ZrO₂.

23. A method for producing a spark plug resistor element arrangement including, in the following order:
an electrically conductive combustion-chamber-side end portion,
a resistor element including a resistance material, and
an electrically conductive connection-side end portion,
wherein the resistor element has a porosity of less than 0.3%,
wherein the method comprises:
comminuting the resistance material to a primary particle size of less than 10 μm.

24. A spark plug for an internal combustion engine, comprising:
a spark plug resistor element arrangement including, in the following order:
an electrically conductive combustion-chamber-side end portion,
a resistor element including a resistance material, and
an electrically conductive connection-side end portion,
wherein the resistor element has a porosity of less than 0.3%.
